(19) United States
(12) Patent Application Publication
(10) Pub. No.: US 2003/0045646 A1
(43) Pub. Date: Mar. 6, 2003

(54) Method for extruding a compressible layer on a printing sleeve

(76) Inventors: Ronald M. Buono, Flat Rock, NC (US); Joseph Carl Kalchbrenner, Greer, SC (US); Stefano Carletti, Urbino (IT); Giorgio Donida Maglio, Offanengo(CR) (IT); Gianpietro Invernizzi, Lodi (IT)

Correspondence Address: PENNIE & EDMONDS LLP, 1667 K STREET NW, SUITE 1000, WASHINGTON, DC, 20006

(21) Appl. No.: 10/191,461

(22) Filed: Jul. 10, 2002

Related U.S. Application Data
(60) Provisional application No. 60/303,775, filed on Jul. 10, 2001.

(51) Int. Cl. C08F 120/44

(52) U.S. Cl. 525/329.1; 525/331.7; 525/333.9

(57) ABSTRACT

A process for preparing a composition including microspheres comprising adding a rubber polymer, a sulfur-based curing agent, and microspheres to a rubber mill mixer and mixing the added materials in the rubber mix to form a composition, wherein the composition comprises less than about 40% solvent. The process is useful for preparing formulations that can be used with printing blanket compressible layers. The microspheres are not adversely affected by the mixing.

### FIELD OF THE INVENTION

The present invention relates to a replaceable sleeve which may be readily mounted onto a cylindrical carrier, for example a replaceable sleeve comprising a multilayer reinforced composite. More particularly, this invention relates to a method of applying a compressible rubber formulation of relatively thick cross-section on a printing blanket by an extrusion process.

### BACKGROUND OF THE INVENTION

Rubber-covered cylindrical rollers are widely used in industry for a number of applications, particularly for web or sheet handling and processing applications such as the embossing, calendering, laminating, printing and coating of paper, film, foil, and other materials. In addition to their use in web processing equipment, such rubber-covered rollers are often employed in conveyors and various office machines. Such rollers are typically comprised of a cylindrical (metal) core or other support with an outer covering of rubber, elastomer, or polymer material. However, after extended use, the covering on the rollers wears down and must be resurfaced or replaced. This typically requires that the rollers be sent to an outside source where the old surface is ground down and a new surface is applied. This is inconvenient and expensive as it requires that the processing equipment be shut down while the roller is being resurfaced or that the end user stock additional replacement rollers.

Cylindrical rollers are widely used in the printing industry. For example, printing rollers or sleeves are used in the flexographic printing industry and in the offset printing industry for providing a mountable surface for flexographic printing plates or offset printing blankets. In a typical flexographic printing press, the sleeve is mounted onto a printing cylinder using pressurized air to expand the sleeve, and the printing plates are then attached to the outer surface of the sleeve. In an offset printing process, the blanket is mounted onto a printing cylinder using pressurized air to expand the blanket.

Typically in blankets, high to medium levels of fillers and blends of fillers have been used. Typically these are low to non-reinforcing in nature. The rubber composition typically comprises polysulfide rubber. For cure systems, conventional systems are used as defined in “The Vanderbilt Rubber Handbook”. Typically the over all recipes resemble the recipes, which can be found in the section on Sponge Rubber found in “The Vanderbilts Rubber Handbook”, medium to highly loaded with non-reinforcing fillers and conventional cure systems. Such rubber compositions have poor wearability and strength.

The introduction of the Sunday Press by Heidelberg M-3000 TM has challenged the printing face prior art by providing operational conditions, which exist outside the experience envelop of the printing face chemistry used on the traditional Flat Blankets. The higher web speeds and the thinner blanket design have challenged the performance of the traditional formulary chemistry used as printing faces on blankets.

Typically in blankets, high to medium levels of fillers and blends of fillers have been used. Typically these are low to non-reinforcing in nature. The rubber composition typically comprises polysulfide rubber. For cure systems, conventional systems are used as defined in “The Vanderbilt Rubber Handbook”. Typically the over all recipes resemble the recipes, which can be found in the section on Sponge Rubber found in “The Vanderbilts Rubber Handbook”, medium to highly loaded with non-reinforcing fillers and conventional cure systems. Such rubber compositions have poor wearability and strength.

A typical formulary for printing faces consists of Thiokol polysulfides at 5-40 phh, Nitrile (29-34% acrylonitrile) at 95-60 phh, silica, for example PPG Hisil 233 (™) at 5-50 phh, processing oil at 2-10 phh, a sulfur cure agent at 0-3 phh, an accelerator at 0-4 phh, a secondary accelerator (Thiuram or Carbamate) at 0-3 phh, and an activator, for example zinc oxide/fatty acid at 1-5 phh. Any of the above groups can be found listed in the recognized Industry reference “The Vanderbilt Rubber Handbook” Thirteenth Edition.

The prior art for preparing a compressible layer for a printing blanket, as discussed in U.S. Pat. No. 5,553,541, utilizes threads as a carrier for the rubber composition and the entrapped microcells. Microspheres from are available commercially from EXPANCEL Inc., an AKZO NOBEL Co., Duluth, Ga. USA. The thickness of the compressible layer is determined by the coating of threads of different thicknesses. The threads act as a carrier for the compressible microcellular rubber formulation, and form a partially inelastic layer of different physical characteristics than the remaining portion of the layers in the blanket. The threads are wound under tension, and the deposited layer typically stratifies to a thread-rich inner portion and a thread-poor outer portion. The use of threads is expensive and time consuming. Additionally, the presence of threads close below the face layer of the printing blanket may cause print imperfections due to a variation in pressure points. The apex of the threads applies more pressure to the printed surface then the area where two threads meet and adjoin each other.

While not used commercially, U.S. Pat. No. 5,323,702 describes applying a compressible layer by metering with a doctor roll, a doctor blade, or by conventional spraying.

The thickness of the compressible layer is determined by the coating of threads of different thicknesses. The threads act as a carrier for the compressible microcellular rubber formulation, and form a partially inelastic layer of different physical characteristics than the remaining portion of the layers in the blanket. The threads are wound under tension, and the deposited layer typically stratifies to a thread-rich inner portion and a thread-poor outer portion. The use of threads is expensive and time consuming. Additionally, the presence of threads close below the face layer of the printing blanket may cause print imperfections due to a variation in pressure points. The apex of the threads applies more pressure to the printed surface then the area where two threads meet and adjoin each other.

The method of manufacture—either thread-carried, or spread with a doctor blade, or sprayed, or rolled on, requires the layers to be fluid. This is achieved by adding solvents to form solvated rubber blends. Typically, the solvated rubber has between 5% and 15% solids, with the balance solvent. The fluid nature is also considered in the art to be essential to the admixing of microcells, which are thin-walled hollow polymeric structures which must be mixed to form substantially homogeneous materials. Uneven concentrations of microcells in the compressible layer caused by poor mixing produces unacceptable blankets. Applicants have found that solvent inclusions that form rogue cells, i.e., undesired openings formed by solvent concentrations, or by solvent entrapment and subsequent vaporization during curing, which impair blanket performance. Additionally, the handling of the solvent posed additional costs and environmental problems.

Additionally, the thread from the manufacture of seamless gapless printing blankets by coating of thread to form a microcellular layer causes problems with printing quality. What is needed is to make such a blanket without thread and to develop a more cost efficient system and environmentally friendly system to produce the components.

### SUMMARY OF THE INVENTION

The invention pertains to a process for preparing a composition including microspheres comprising adding a rubber polymer, a sulfur-based curing agent, and microspheres to a rubber mill mixer, for example, a two roll mixer, and mixing the added materials in the rubber mix to form a composition, wherein the composition comprises less than about 40% solvent.

The process with a rubber composition comprising butyl rubber, nitrile rubber, EPDM rubber, natural rubber, synthetic rubber, neoprene rubber, polysulfide rubber, elastomeric polyurethane, isoprene rubber, an isoprene acrylonitrile polymer, nitrile-butadiene polymer, nitrile-butadiene-isoprene terpolymers, neoprene, or a mixture thereof. The microspheres beneficially comprise unexpanded microspheres, and the microspheres are added with at least about 10% by weight of a fluid composition comprising monomers, low molecular weight prepolymers, low molecular weight polymerizable compounds, or mixtures thereof.

In an additional embodiment, the microspheres comprise unexpanded microspheres, and the microspheres are added with between about 10% and about 60% by weight of a composition comprising monomers, low molecular weight prepolymers, low molecular weight polymerizable compounds, or mixtures thereof. More preferably, the microspheres comprise unexpanded microspheres, and the microspheres are added with between about 20% to about 40% by weight of a composition comprising monomers, low molecular weight prepolymers, low molecular weight polymerizable compounds, or mixtures thereof.

In a further embodiment, the microspheres comprise expanded microspheres, and the microspheres are added with at least about 15% by weight of a composition comprising monomers, low molecular weight prepolymers, low molecular weight polymerizable compounds, or mixtures thereof. The microspheres advantageously comprise expanded microspheres, and the microspheres are added with between about 15% and about 120% by weight of a composition comprising monomers, low molecular weight prepolymers, low molecular weight polymerizable compounds, or mixtures thereof.

In another embodiment, the monomers, low molecular weight prepolymers, or low molecular weight polymerizable compounds comprise ethylene vinyl acetate, a low viscosity urethane, or mixtures thereof.

Advantageously, the composition comprises less than about 20% solvent. The composition may comprise less than about 5% solvent.

In a preferred embodiment, the microspheres have an expansion temperature, and the temperature of the composition is at least 10 degrees F. below the expansion temperature of the microspheres, so that the microspheres do not expand during mill mixing.

Another aspect of the invention is a process for extruding a layer of a printing blanket comprising the steps of providing a rubber composition; maintaining the temperature of the rubber composition at a temperature where the rubber composition is extrudeable; and extruding through a die a film adapted for use on a printing blanket, wherein the rubber composition in the film contains less than about 40% solvent. The rubber composition advantageously contains less than about 20% solvent. The thickness of the films between about 0.05 inches to about 0.20 inches. This process is amenable for forming a layer for a gapless and seamless cylindrical blanket.

Advantageously, the rubber composition contains less than about 5% solvent. The rubber composition in some embodiments comprises microspheres, and the extrusion temperature is between about 130° F. and about 250° F. When rubber composition comprises microspheres, the extrusion temperature is preferably between about 150° F. and about 220° F.

In an additional embodiment, the film is in the form of a cylinder sized to fit at a layer of a printing blanket, the film has no microspheres and the extrusion temperature is between about 130° F. to about 300° F. The extrusion temperature is in this embodiment is preferably between about 160° F. to about 250° F.

Another embodiment encompasses the process as further comprising the step of affixing the extruded film to a printing blanket assembly. In one embodiment, the film is a ribbon and is spiral wound around a printing blanket assembly.

In a particularly preferred embodiment, the extrudate is formed in a circular annulus die with the rubber composition being extruded over a held printing blanket assembly, wherein the outer edge of the die forms the outer diameter of the extruded composition and the inner edge is formed by a moving printing blanket which advances through the center of the die at a rate substantially equal to the rate of formation of the extrudate. The seamless extrudate layer is thereby deposited directly n the printing blanket.

In another preferred embodiment, the printing blanket has an area adapted for printing, and the printing area is also devoid of threads winding around the printing area of the blanket.

### DETAILED DESCRIPTION OF THE INVENTION

The invention relates to forming a printing blanket by applying on a primed sleeve a compressible layer and/or a reinforcing layer, and a printing face layer. The invention more particularly relates to a mixing process and an extrusion process for one or more of the aforesaid layers.

According to one aspect of the present invention, a replaceable blanket is provided which is adapted to be mounted on a carrier. By carrier, we mean any structure which functions to support the sleeve during use and allows it to rotate during use including but not limited to cylinders, tubes, and liners. The replaceable blanket is made up of a combination of layers including an inner sleeve, optionally a reinforcing layer overlying the inner sleeve, an intermediate compressible polymeric layer overlying sleeve/reinforcing layer, optionally a reinforcing layer overlying the compressible layer, and an outer polymeric layer forming a working, i.e., printing, surface.

One aspect of the invention involves preparing the elastomeric compositions utilizing less solvent than prior art systems.

The compressible layer may comprise of an open or closed-cell polymeric foam. The cell structure of the foam, may be created with suitable chemical blowing agents such as magnesium sulfate, hydrated salts, hydrazides such as p-toluene sulfonyl hydrazide and p,poxybisbenzene sulfonyl hydrazide, and carbonamides such as 1,1′-azobisformamide, nitrate, nitrite, bicarbonate and carbonate salts. Still another preferred method of forming the compressible layer includes the incorporation of microcapsules.

The other ingredients to the rubber formula such as reinforcing fillers, processing oils, and cross-linking systems all are integral in providing the final physical performance properties of the mixture as it is cured into it's final form as a product. Prior art consists of blended carbon black grades. Blends of fillers, specifically carbon blacks, is not recommended. Without being bound to theory, it is believed that there is negative synergy between multiple filler components.

The compressible layer rubber compound for printing blankets of the present invention provide high strength and low heat generation that are key to longevity of the performance.

In one embodiment, this compressible layer comprises a composition formed from a nitrile-butadiene coplymer, hydrogenated nitrile-butadiene copolymer, carboxylated nitrile-butadiene copolymer, nitrile-butadiene-isoprene terpolymers, neoprene, isoprene, epoxidized isoprene, SBR, or any of the polyurethane elastomeric rubbers, or blends of such. The cell structure of the compressible layer may be created with suitable chemical blowing agents such as magnesium sulfate, hydrated salts, hydrazides such as p-toluene sulfonyl hydrazide and p,poxybisbenzene sulfonyl hydrazide, and carbonamides such as 1,1′-azobisformamide, nitrate, nitrite, bicarbonate and carbonate salts. Still another preferred method of forming the compressible layer includes the incorporation of microcapsules, for example microcells.

In another embodiment, a compressible layer applied comprises nitrile-butadiene coplymer, hydrogenated nitrile-butadiene copolymer, carboxylated nitrile-butadiene copolymer, nitrile-butadiene-isoprene terpolymers, neoprene, isoprene, epoxidized isoprene, SBR, or any of the polyurethane elastomeric rubbers, or blends of such. Layers can be applied by spreading, spraying, or extruding over the compressible layer. The reinforcing layer is designed in composition, via polymeric composition or reduction in cell density versus the compressible layer, to posses physical properties of higher hardness, static modulus, dynamic modulus as compared to the compressible layer. The compressible layer benefits from and is structurally strengthened by the addition of the reinforcing layer.

In one embodiment the rubber compound comprises Butadiene, Isoprene, an acrylonitrile-butadiene-isoprene terpolymer, or a mixture thereof. The butadiene and/or isoprene can be in the form of a copolymer or terpolymer, which may be either random or block. A preferred embodiment comprises at least 30%, more preferably at least 60%, of the acrylonitrile-butadiene-isoprene terpolymer, beneficially admixed with butadiene or copolymer thereof, isoprene or copolymer thereof, or a mixture thereof. The acrylonitrile content of the terpolymer provides oil and solvent resistance. A preferred acrylonitrile-butadiene-isoprene terpolymer is DN1201 (™) available commercially from Zeon.

Other components and additives are beneficially added to the composition. For example, oils, preferably aromatic oils which are at least partially polymerized into the composition during processing, are beneficially added at a rate of between about 5 pph and 30 pph, preferably at a rate of between about 15 pph and about 20 pph. Resins, for example wood resins, are beneficially added at a rate of between about 1 pph and about 20 pph, preferably at a rate of between about 5 pph and about 10 pph. Modifiers, for example fatty acids or their salts, i.e., stearic acid or zinc stearate, are beneficially added at between about 0.1 pph to about 10 pph, preferablybetween about 0.5 pph to about 3 pph. Additional zinc, or other crosslinking agent, can be added at a rate of between about 2 pph and about 15 pph, for example between about 6 pph and about 10 pph. Sulfur and sulfur-containing curing agents are added as needed, for example at a rate of between about 1 pph to about 8 pph. Pph means parts by weight in 100 parts of the base polymer(s).

The filler can be any type normally used in the art. A preferred filler comprises reinforcing carbon black fillers which have particle size as measured by the Iodine # of 20 to 100, preferred 30 to 60, more preferred 40 to 50, to provide a balance between abrasion resistance and heat build-up. The structure of the reinforcing carbon black as measured by the DBP # for best performance will be about 50 to about 150, preferred about 80 to 130, more preferred 105 to 125, to provide the best balance between tear resistance and modulus. The loading or percent of filler in the total recipe should be between about 8 to about 70 phr, preferably between about 13 to about 50 phh, more preferably about 15 pph to about 37 pph, for example about 22 pph..

The cure system can include any cure system known to one of skill in the art, such as those described in “An Efficient Vulcanization System” by “The Vanderbilt Rubber Handbook”. Preferably the cure system produces a predominance, i.e., greater than 50%, preferably greater than 70%, of mono and disulfide crosslinks which have greater thermal and mechanical stability than polysulfide crosslinks which are produced by conventional sulfur cures.

The preferred formulation, when tested according to ASTM D623 to the “Blowout Condition” on a Goodrich Flexometer (™) will provide a result of 30 minutes minimum, preferably 45 minutes minimum, more preferably 60 minutes minimum.

In one embodiment, the cure system contains: sulfur at 0.1 to 3 phh, preferably 1 to 2 phh;

a primary accelerator (Dithiodimorpholine, Thiazole or Sulfenamide) at 0 to 4 phh, preferably 1.5 to 3.5 phh; and a secondary accelerator (Thiuram or Carbamate) at 0 to 3 phh, preferably 1 to 2 phh.

The preferred cure system would be considered a semi-EV system where some polysulfide crosslinks are desired to improve tear strength, adhesion, and modulus due to low levels of reinforcing filler. A lower loading of reinforcing filler is desired to reduce the heat generation, which occurs during repeated flexing or repeated compression.

Another aspect of the invention includes the addition of antioxidants and antiozonants at levels of 1 to 9 phh, preferred 1.5 to 6 phh, more preferred 2 to 4 phh, for the stabilization of the physical properties and performance over time.

The inner compressible layer and intermediate reinforcing layer can also include butyl rubber, nitrile rubber, EPDM rubber, natural rubber, synthetic rubber, neoprene rubber, polysulfide rubber, a blend of nitrile rubber and polyvinyl chloride, polyurethane, and mixtures thereof. Preferably these compounds together comprise less than 50 percent by weight of the base polymer, more preferably less than about 20% of the base polymer.

The compressible layer is placed on a blanket including but not limited to cylinders, tubes, flat blankets, blankets used for flexographic printing blankets, and liners. The replaceable blanket is made up of a combination of layers including an inner sleeve, optionally a reinforcing layer overlying the inner sleeve, an intermediate compressible polymeric layer overlying sleeve/reinforcing layer, optionally a reinforcing layer overlying the compressible layer, and an outer polymeric layer forming a working, i.e., printing, surface.

The inner sleeve can be either metallic or non-metallic, i.e., polymeric. While thin metal sleeves for use on printing cylinders have been employed in the past, more recently, printing sleeves have been developed which are comprised of polymeric materials. For example, printing sleeves are known which include laminated polymeric layers reinforced with a woven or nonwoven fabric layer. Such sleeves provide an advantage over metal rollers in that they are readily expandable for mounting on a cylinder, are seamless, and provide good structural integrity for printing operations without the damage and safety limitations of thin metal sleeves. The sleeve may have a reinforcing layer, and may have a coating or layer on the internal diameter to provide the desired friction or holding strength to the roller. The sleeve can be either a sleeve, a primed sleeve, or a sleeve with one or more coatings affixed thereto.

The inner compressible layer, intermediate layer, and outer layer are comprised of an elastomeric material selected from, but not limited to, the group consisting of butyl rubber, nitrile rubber, EPDM rubber, natural rubber, synthetic rubber, neoprene rubber, polysulfide rubber, a blend of nitrile rubber and polyvinyl chloride, polyurethane, and mixtures thereof.

The compressible or cushion layer functions to provide energy absorption and resiliency to the blanket while allowing strain deformations to occur in the radial direction with little to no Poisson's effect occurring at the printing interface. This radial compressibility is needed to keep the printing within the required specs. The compressible layer may comprise of an open or closed-cell polymeric foam.

In one embodiment, this compressible layer comprises a composition formed from a nitrile-butadiene coplymer, hydrogenated nitrile-butadiene copolymer, carboxylated nitrile-butadiene copolymer, nitrile-butadiene-isoprene terpolymers, neoprene, isoprene, epoxidized isoprene, SBR, or any of the polyurethane elastomeric rubbers, or blends of such. The cell structure of the compressible layer may be created with suitable chemical blowing agents such as magnesium sulfate, hydrated salts, hydrazides such as p-toluene sulfonyl hydrazide and p,poxybisbenzene sulfonyl hydrazide, and carbonamides such as 1,1′-azobisformamide, nitrate, nitrite, bicarbonate and carbonate salts. Still another preferred method of forming the compressible layer includes the incorporation of microcapsules, for example microcells.

In another embodiment, a compressible layer is applied to a sleeve and a reinforcing layer comprising a non-thread polymeric layer consisting of a nitrile-butadiene coplymer, hydrogenated nitrile-butadiene copolymer, carboxylated nitrile-butadiene copolymer, nitrile-butadiene-isoprene terpolymers, neoprene, isoprene, epoxidized isoprene, SBR, or any of the polyurethane clastomeric rubbers, or blends of such, is applied by electrostatic spraying over the compressible layer. The reinforcing layer is designed in composition, via polymeric composition or reduction in cell density versus the compressible layer, to posses physical properties of higher hardness, static modulus, dynamic modulus as compared to the compressible layer. The compressible layer benefits from and is structurally strengthened by the addition of the reinforcing layer.

The prior art solvated the rubber compositions to both mix the components and to transfer the resulting compositions to the thin blankets. We have found that the components can be mixed by regular rubber mill mixing. Most surprisingly, we have discovered that microcells, both preexpanded and preferably unexpanded, survive and are adequately mixed in a mill mixer.

The use of pre-expanded microspheres such as 461-DE from Expancel to manufacture a printing blanket compressible layer is well known. The use of these pre-expanded microspheres has in the past been limited to liquid or low shear systems using water or solvent as a carrier fluid. Weighing and handling of pre-expanded microspheres is a health problem in addition to a technical problem. The microspheres become airborne and have a tendency to “float”. They are difficult to weigh and to transfer from place to place.

We have found that unexpanded and expanded, preferably unexpanded, microspheres that are pre-mixed into a polymeric binder system of for example Ethylene Vinyl Acetate polymer can be measured and easily utilized. Any monomer or low molecular weight prepolymer, or both, that is compatible with the microcells can be used. Beneficially, the monomer or low molecular weight prepolymer, or both, are polymerized and incorporated into the rubber composition during subsequent processing and curing. The amount of monomer/prepolymer used is preferably a minimum needed to coat and hold the microspheres. For expanded microspheres, a composition may be 15% to 120% by weight, preferably between about 40% to about 70% of monomer/prepolymer, with the balance being expanded microcells. The use of this monomer/prepolymer material with unexpanded microcells, such as Expancel MB, reduces the amount of monomer/prepolymer needed to between about 10% to about 60%, preferably between about 20% to about 40% by weight monomer/prepolymer, with the remainder being microspheres. Of course, a mixture of expanded and unexpanded microcells can be used in this aspect of the invention, wherein the required amount of monomer/prepolymer will depend on the relative fractions of each.

This admixing of the microcells with monomers, low molecular weight prepolymers, or low molecular weight polymerizable compounds is advantageous in systems where the manufacturing process is adapted to minimize or eliminate solvent. The microcell/monomer/prepolymer mix, for example 65% unexpanded microcells and 35% Ethylene Vinyl Acetate polymer, allows precise measuring and mixing in all the traditional methodologies but additionally allows the use of high shear mixing equipment such as two roll mill, calendaring, and shear intensive internal mixers such as a Shaw Intermix, or Farrel's Banbury mixer or a Werner & Pfliderer Rubber Internal Mixing Device.

In one aspect of the invention, polymerizable monomers and low molecular weight prepolymers, i.e., dimers and the like, can be added to rubber formulations to lower the viscosity of the rubber composition while still minimizing or eliminating solvents. Applicable monomers, dimer, and prepolymers include compounds comprising ethylene vinyl acetate or any alkene vinyl acetate, vinyl acetate, (meth)acrylates, surfactant monomers and the like, such that the formulation has a viscosity of about 100 or less at processing temperature.

Advantageously, solvents are minimized or eliminated. Prior art formulations contained as little as 55 to 155 solids in solvent. The use of internal mixers, also called rubber mills, to make compressible layer materials substantially eliminates the need to use hazardous solvated mixtures. Preferably, the compressible and/or reinforcing rubber mixture applied to a printing blanket will have less than 65% solvent, preferably less than about 40% solvent, more preferably less than about 20% solvent, most preferably less than about 5% solvent, for example no solvent. As used herein, the term solvent means a material that lowers the viscosity of the rubber mixture during processing and/or applying the composition to the printing blanket assembly, but that is not incorporated into the rubber composition, and that typically has a vapor pressure such that vapor bubbles can form during vulcanization.

If solvents are added to the composition, beneficially the solvent is Methyl Isobutyl Ketone, MIBK. In another embodiment the solvent comprises a mixture of Toluene, Ethyl Acetate and a Ketone. In a third embodiment, the solvent comprises a mixture of between 5% to 50% Methyl Amyl Ketone, preferably 10%-30%, more preferably 18%-25% where the balance is substantially MIBK. The preferred organic solvent is capable of solvating the rubber composition and which does not unduly attack microsphere.

The use of mill-mixed unexpanded microspheres, for example Expancel MB, to manufacture a compressible layer material by extrusion or crosshead extrusion in place of a coating or spraying or thread-carried transfer processes will reduce or eliminate the need to use a solvent to manufacture a compressible layer material in a printing blanket or a seamless/gapless printing sleeve. Expanded microcells can also be used, but they are more prone to distruction during the processing unless the composition has a lower viscosity than can be used with unexpanded microcells.

In one embodiment the rubber compound comprises Butadiene, Isoprene, an acrylonitrile-butadiene-isoprene terpolymer, or a mixture thereof. The butadiene and/or isoprene can be in the form of a copolymer or terpolymer, which may be either random or block. A preferred embodiment comprises at least 30%, more preferably at least 60%, of the acrylonitrile-butadiene-isoprene terpolymer, beneficially admixed with butadiene or copolymer thereof, isoprene or copolymer thereof, or a mixture thereof. The acrylonitrile content of the terpolymer provides oil and solvent resistance. A preferred acrylonitrile-butadiene-isoprene terpolymer comprises 10 to 60% acrylonitrile, preferably between about 20 to 50% acrylonitrile, more preferably between about 30 to 40% each of acrylonitrile and butadiene, and the balance isoprene. A preferred acrylonitrile-butadiene-isoprene terpolymer is DN1201 (™) available commercially from Zeon Chemical Co. of Louisville, Ky.

In another preferred embodiment, the compressible layer comprises isoprene, an acrylonitrile-isoprene copolymer, an acrylonitrile-isoprene-X terpolymer where X is another monomer, an acrylonitrile-X copolymer where X is another monomer, an an acrylonitrile-Y-X terpolymer where X and Y are monomers, or a mixture thereof. Beneficially, the acrylonitrile content of the copoylmer or terpolymer is greater than 40%. Preferred copolymers which are available commercially include ZEON 1031 and NITRIFLEX N386B.

In one embodiment, the compressible layer includes a mixture of the above terpolymer and nitrile rubber, where the ratio of the terpolymer to nitrile can be 10:1 to 1:10, preferably between about 4:1 to about 1:4.

Other components and additives are beneficially added to the composition. For example, oils, preferably aromatic oil with a high number of hydroxyl groups, for example polyester phthalate processing oil such as is commercially available from C.P.Hall of Chicago as P-900 (™), which are at least partially polymerized into the composition during processing, are beneficially added at a rate of between about 5 pph and 30 pph, preferably at a rate of between about 15 pph and about 20 pph. Resins, for example wood resins, are beneficially added at a rate of between about 1 pph and about 20 pph, preferably at a rate of between about 5 pph and about 10 pph. Two step reactive resins, for example AKROCHEM P-87 (™) are also preferred. Modifiers, for example fatty acids or their salts, i.e., stearic acid or zinc stearate, are beneficially added at between about 0.1 pph to about 10 pph, preferably between about 0.5 pph to about 3 pph. Additional zinc, or other crosslinking agent, can be added at a rate of between about 2 pph and about 15 pph, for example between about 6 pph and about 10 pph. Sulfur and sulfur-containing curing agents are added as needed, for example at a rate of between about 1 pph to about 8 pph. Pph means parts by weight in 100 parts of the base polymer(s).

The filler can be any type normally used in the art. A preferred filler comprises reinforcing carbon black fillers which have particle size as measured by the Iodine # of 20 to 100, preferred 30 to 60, more preferred 40 to 50, to provide a balance between abrasion resistance and heat build-up. The structure of the reinforcing carbon black as measured by the DBP # for best performance will be about 50 to about 150, preferred about 80 to 130, more preferred 105 to 125, to provide the best balance between tear resistance and modulus. The loading or percent of filler in the total recipe should be between about 8 to about 70 phr, preferably between about 13 to about 50 phh, more preferably about 15 pph to about 37 pph, for example about 22 pph..

The cure system can include any cure system known to one of skill in the art, such as those described in “An Efficient Vulcanization System” by “The Vanderbilt Rubber Handbook”. Preferably the cure system produces a predominance, i.e., greater than 50%, preferably greater than 70%, of mono and disulfide crosslinks which have greater thermal and mechanical stability than polysulfide crosslinks which are produced by conventional sulfur cures.

The extruded compressible or cushion layer functions to provide energy absorption, and resiliency to the blanket while allowing strain deformations to occur in the radial direction with little to no Poisson's effect occurring at the printing interface to kept the printing within the required specs. The compressible layer may comprise of an open or closed-cell polymeric foam. The cell structure of the foam, may be created with suitable chemical blowing agents such as magnesium sulfate, hydrated salts, hydrazides such as p-toluene sulfonyl hydrazide and p,poxybisbenzene sulfonyl hydrazide, and carbonamides such as 1,1′-azobisformamide, nitrate, nitrite, bicarbonate and carbonate salts. Still another preferred method of forming the compressible layer includes the incorporation of microcapsules. The preferred embodiment contains unexpanded microspheres from Expancel TM where the microspheres are added to the elastomeric material via mill mixing. The face layer may be strip built in the same fashion. One method of incorporating cells is by adding expanded and/or expandable microspheres. The number of microspheres in the rubber composition can range from about 0.1 to 20%, preferably from about 2% to about 5%.

The composition, including microcells if the composition is a microcell-containing compressible layer, are mixed in a rubber mill. One of ordinary skill in the art can adjust the parameters of the mill to adequately mix the composition. Advantageously, the temperature is kept below the expansion temperature of the microcells. The mixing process temperature must be kept below 250° F. preferably below 200° F. to avoid premature expansion or “blowing” of the microspheres. Different microspheres have different expansion temperatures. The mixing temperature should be kept at least 10° F. below the recommended expansion temperature during the rubber mixing operation.

As used herein, microcells and microspheres are used interchangably, and the microsphere need not be spherical in shape, especially before expansion.

Once the unexpanded microspheres are mixed into a preferred compressible rubber formulation such as described above, the rubber can be applied by any one of a variety of methods such as spray, extrusion, crosshead extrusion, hand wrapping, molding, and calendaring. Spraying may require addition of a solvent. The preferred method of applying the composition to the printing blanket is by extrusion, cross-head extrusion or calendaring.

The extrusion method of applying the composition to the printing blanket is preferred, because this method emphasizes the advantages of a low solvent or solventless composition. An extruder is a devise that heats and softens uncured, un-vulcanized elastomeric materials such that the material may be shaped and formed by passage through an orifice called a die. One embodiment, this extruder forms a continuous ribbon or strip of elastomer, which maybe wound onto a high modulus/low elongation sleeve, typically preferred a thin 0.003″ to 0.010″ nickel alloy, but not limited to, a group of high modulus/low elongation film type substrates of non-metallic and metallic structure. This strip may be the full width of the cylinder, or may be in narrower widths, which are spirally wound onto the sleeve substrate. A spiral wound strip may consist of a winding, which may have a gap, a butt seam, or an overlap seam, at any spiral angle from <90 degrees perpendicular to >0 degrees from the surface.

The extruded strip can be of any thickness, though one preferred thickness is the approximate thickness of the layer, for example the compressible layer, the reinforcing layer, and/or the printing face layer. Such layers vary from about 0.05 inches to about 0.20 inches in thickness. Altenatively, the extruded strip or film can be one half or one third the thickness of the desired layer, though thin films are difficult to handle.

The elastomer consisting of a nitrile-butadiene coplymer, hydrogenated nitrile-butadiene copolymer, carboxylated nitrile-butadiene copolymer, nitrile-butadiene-isoprene terpolymers, neoprene, isoprene, epoxidized isoprene, SBR, EPDM, butyl, halogenated butyl, fluoroelastomers, or any of the polyurethane elastomeric rubbers, or blends of such is thereby applied directly to the blanket without using threads.

The advantages are the elimination of using solvents and thread to manufacture these components, thus saving cost and environmental hazards. Building rates are also much increased producing more parts per man-hour.

In another embodiment, the extrudate is extruded through an circular die which has been designed to have a specific OD (outside diameter) and ID (inside diameter). This ID/OD extrusion has an advantage over the strip built extrusion by not having any seam lines. The elastomer tube is formed seamless inside the extruder head and die forming a continuous tube. This tube can be cooled and cut to length for sliding over a sleeve substrate via for example air bearing. A non-thread compressible, reinforcing, and printing face layer may be formed by this method. Beneficially, we have found the the extrusion is best performed in a vertical orientation, so that gravity does not unduly distort the extruded sheet or cylinder.

In another preferred embodiment, the extrudate is formed in a circular annulus die with the elastomer being pumped from the outside towards a previously mentioned sleeve, which is mounted on a rigid core (mandrel). The outer edge of the die forms the OD of the extrudate and the inner edge is formed by the moving sleeve/mandrel combination, which advances through the center of the die at an equal or near equal rate to the formation of the extudate (skin) on the sleeve. This is called Cross-head extrusion. The advantage to cross-head extrusion is being able to have the most precise control of elastomer gauge during extrusion, thus controlling material use, and providing high pressure to force the hot molten elastomer onto a substrate, reducing any occurrence of air or other foreign material entrapment at the knit or boundary line, between substrates. A non-thread compressible, reinforcing, and Printing face layer may be formed by this method.

The extrusion temperature is for example between about 130° F. and about 250° F., preferably between about 150° F. and about 220° F., more preferably between about 170° F. to about 190° F., for extrusion of the Compressible Layer containing microspheres. An elastomeric reinforcing layer and elastomeric printing face without microspheres can utilize a higher extrudate temperature, for example from about 130° F. to about 300° F., more preferably between 160° F. to about 250° F., most preferably between about 170° F. to 230° F.

In one aspect of the invention, the compressible layer is applied by crosshead extrusion, and the printing face layer and/or reinforcing layer are applied by ID/OD extrusion and fitting.

In another aspect of the invention, a reduced solvent or solvent-free printing face layer is produced by mill mixing. Preferably, the printing face rubber mixture applied to a printing blanket will have less than 65% solvent, preferably less than about 40% solvent, more preferably less than about 20% solvent, most preferably less than about 5% solvent, for example no solvent. Then, the printing face layer is applied over the compressible layer and reinforcing layer, if any. The printing face may include a nitrile-butadiene copolymer, a hydrogenated nitrile-butadiene copolymer, a carboxylated nitrile-butadiene copolymer, a nitrile-butadiene-isoprene terpolymers, neoprene, isoprene, epoxidized isoprene, SBR, EPDM, butyl, halogenated butyl, fluoroelastomers, or any of the polyurethane elastomeric rubbers, or blends thereof.

The printing face composition may also include fillers, wettability modifiers, basicity modifiers, crosslinkers, and the like. The solvated rubber composition may optionally include a binder capable of forming a bond with one or more particulate fillers such as barite, silica, carbon black, polysulfide rubber, microcells, and the like, such as carboxylated styrene butadiene latex, styrene-acrylic copolymer latex, acrylic latex, vinyl acrylic latex, urethane (aromatic and aliphatic), diphenylmethane diisocyanate-urethane (MDI), and toluene diisocyanate (TDI).

One aspect of the invention is a printing face composition comprising:

a base of 100 parts of nitrile with between about 35% to about 50% by weight acrylonitrile, preferably with about 36% to about 45% by weight acrylonitrile, more preferred 39% to 41% by weight acylonitrile;

silica, for example commodity grade, preferably with pH in caustic range, i.e., pH >7, preferably pH is between 9 to 11, more preferably between 9.5-10.5, at 5 to 50 phh, preferably between about 15 phh to about 25 phh;

an coupling agent, i.e., an organosilane coupling agent at a quantity of between about 0.1-15 phh, preferably between about 3 to about 5 phh;

an aromatic oil with a high number of hydroxyl groups, for example polyester phthalate processing oil such as is commercially available from C.P.Hall of Chicago as P-900 (™) at a rate of about 5 to about 60 phh, more preferably between about 15 to about 25 phh, for example 20 phh;

sulfur at about 0 to about 3 phh, preferably between about 0.1 to about 3 phh, more preferably between about 1.2 to about 2.2 phh;

advantageously a primary accelerator, i.e., Dithiodimorpholine, Thiazole and/or Sulfonamide at a rate of between about 0.1 to about 4 phh, preferably between about 1.5 phh to about 3 phh;

advantageously a secondary accelerator, i.e., Thiuram or Carbamate, at a rate of between about 0.1 to about 3 phh, more preferably between about 0.25 to about 1.5 phh;

an activator, i.e., zinc oxide/fatty acid combination or a zinc or other metal salt of a fatty acid, at a rate of between about 1 to about 10 phh, preferably at a rate of between about 5 to about 8 phh;

advantageously other metal oxides, for example TiO2, MgO, and/or CaO, at a rate of between about 1 to about 20 phh, preferably at a rate of between about 5 to about 12 phh; and

advantageously an antioxidant/antiozonate at a rate of between about 1 phh to about 8 phh, preferably between about 2 to about 5 phh.

The nitrile used in prior art blankets has between about 30% to about 33% acrylonitrile. The inventors unexpectedly found that by increasing the acrylonitrile content of the nitrile to about 38% or more, the composition had oil and solvent resistance and release characteristics similar to a polysulfide-containing blanket.

A coupling agent, for example an agent which links the polymeric backbone to the filler, is advantageously included. This coupling agent allows the inorganic filler to contribute to the strength and tear resistance of the composition. The coupling agent can be an organosiloxane, for example a polysiloxane. Advantageously this coupling agent is added at an amount equal to about 0.05 to about 0.25 times the amount of silica added to the composition.

In a preferred embodiment a halogenated compound, for example a halogenated prepolymer, for example a fluorosurfactant, i.e., Zonyl (™) from DuPont, Lodyne (™) from Ciba, Bayowet (™) from Bayer, is added to the above formulation in an amount sufficient to increase the hydrophilicity of the composition, for example at a rate of between about 0.1 phh to about 20 phh, more preferably between about 3 phh to about 8 phh. A preferred fluorosurfactant is a fluorinated polyethylene glycol.

In another embodiment, surfactant monomers or prepolymers, for example carboxylates, i.e., itaconic acid or (meth)acrylic acids, sulfonates, for example p-sulfophenyl methallyl ether, allyl sulfonates, styrene sulfonates, ethylene carbonate, dimethylsulfoxide, and the like can be added to the composition in an amount between about 0.1 to about 3 phh. These surfactant monomers will make the composition more hydrophillic.

Another aspect of the invention is higher tear and cut strength. The rogue cell containing polysulfide-based composition of the prior art had poor mechanical strength. The advantage over prior art is better life on the press, fewer paper cuts, and face damage from smashes and paper wrapping. Advantageously, the printing face layer has a tensile strength greater than about 600 psi, preferably greater than about 1000 psi, and the elongation at break is greater than 250%, preferably greater than 400%.

The extrusion process is amenable for providing threadless printing blankets. The threadless printing blanket for the gapless seamless printing blanket market includes a plurality of layers, including a substantially cylindrical sleeve, a threadless compressible layer or cushion layer, optionally a threadless reinforcing layer, and a threadless printing face layer. Threads are believed to affect print quality and create undesired pressure lines in the printing face, which transfers the ink to paper at variations in intensities. A threadless blanket would be an improvement over current and prior art for print quality.

In one embodiment, the blanket contains a high modulus/low elongation sleeve. This sleeve is typically a thin 0.003″ to 0.010″ nickel alloy sleeve that has been primed with one or two primers which promote adhesion of the compressible layer onto the sleeve. This invention is not limited to metallic sleeves, however, and can be applied to ant suitable high modulus/low elongation film type substrates of non-metallic and metallic structure.

In one embodiment, the compressible layer may be applied by spraying, and the reinforcing and/or printing face layer may be applied by extrusion, i.e., crosshead extrusion, ID/OD extrusion, or film extrusion and wrapping. In one embodiment, the compressible layer may be applied by extrusion, i.e., crosshead extrusion, ID/OD extrusion, or film extrusion and wrapping, and the reinforcing and/or printing face layer may be applied by spraying. Spraying allows the sprayed layer to incorporate compositional and/or thickness gradients.

Once the rubber is applied to a printing blanket or a sleeve, the curing process becomes very critical. The curing process, and resulting expansion and/or compression of microcells, will control the size of the voids in the compressible layer. The number of voids is controlled by the weight or number of microspheres.

In the traditional solvated mixing and curing processes controlling the weight and the size of microcells was difficult because the solvents would chemically attack and destroy a certain pecentage of microspheres, and/or solvent vapors would add vapor pressure to a void. A certain number of microspheres would be “lost” in weighing and mixing into the solvated raw material. Solvent bubbles would be trapped along with micropsheres in the compressible layer causing large undesirable voids in the otherwise uniform compressible layer. The common methods used to measure the compressible layer uniformity is “compliancy or compression deflection”. When the precise number of microspheres can be weighed into a rubber formulation and when the rate of expansion can be controlled by time and temperature during the curing cycle of the rubber article a more uniform and consistent compressible layer can be formed on various printing articles such as flat fabric blankets and round seamless gapless printing sleeves.

The time for curing is not limited but can be 5 minutes to 48 hours with the preferred time being between 30 minutes and 8 hours. With more preferred time is between about 30 minutes to 1.5 hours. The temperatures can vary from 75° F. (room temperature) to about 350° F. The more preferred temperature is 180° F.-300° F. A very controlled temperature cycle is desired to give the optimum results. Starting at room temperature or a low temperature, say for example from about 60° F. to about 150 F., and increasing temperature slowly at a prescribed rate of from 1° F.-50° F. per minute more preferably at between 3° F.-20° F. and most preferably at 3°-10° F. per minute will achieve optimum results. The temperature during the mixing of the rubber should be controlled to prevent the microspheres from being destroyed both during mixing and during curing.

Pressure must be controlled along with temperature during curing, both to prevent entrapped gases or solvents from forming rogue cells and also to controll the size of the expanding microcells.. That is, if the pressure is too high the microspheres will not expand. If the pressure is not high enough moisture, air and other gasses will expand and form undesirable “blisters” or gas pockets in the rubber and also cause bad bond in the case of sleeves. The pressure can be from 0.1 to 100 psi gauge but more preferably it will be between 0.3-30 psi gauge and most preferably it will be between 5-15 psi gauge during the curing of the compressible layer material.

It is recognized that the cured printing blanket will contain substantially no solvent, and few if any of the polymeric compounds mentioned as ingredients. The compositions and solvent concentrations are expressed as what would be found when the composition is applied to the printing blanket, before drying, curing, and vulcanization.

We claim:

1. A process for preparing a composition including microspheres comprising:
adding a rubber polymer, a sulfur-based curing agent, and microspheres to a rubber mill mixer; and
mixing the added materials in the rubber mix to form a composition, wherein the composition comprises less than about 40% solvent.

2. The process of claim 1 wherein the rubber polymer comprises butyl rubber, nitrile rubber, EPDM rubber, natural rubber, synthetic rubber, neoprene rubber, polysulfide rubber, elastomeric polyurethane, isoprene rubber, an isoprene acrylonitrile polymer, nitrile-butadiene polymer, nitrile-butadiene-isoprene terpolymers, neoprene, or a mixture thereof.

3. The process of claim 1 wherein the microspheres comprise unexpanded microspheres, and the microspheres are added with at least about 10% by weight of a composition comprising monomers, low molecular weight prepolymers, low molecular weight polymerizable compounds, or mixtures thereof.

4. The process of claim 1 wherein the microspheres comprise unexpanded microspheres, and the microspheres are added with between about 10% and about 60% by weight of a composition comprising monomers, low molecular weight prepolymers, low molecular weight polymerizable compounds, or mixtures thereof.

5. The process of claim 1 wherein the microspheres comprise unexpanded microspheres, and the microspheres are added with between about 20% to about 40% by weight of a composition comprising monomers, low molecular weight prepolymers, low molecular weight polymerizable compounds, or mixtures thereof.

6. The process of claim 1 wherein the microspheres comprise expanded microspheres, and the microspheres are added with at least about 15% by weight of a composition comprising monomers, low molecular weight prepolymers, low molecular weight polymerizable compounds, or mixtures thereof.

7. The process of claim 1 wherein the microspheres comprise expanded microspheres, and the microspheres are added with between about 15% and about 120% by weight of a composition comprising monomers, low molecular weight prepolymers, low molecular weight polymerizable compounds, or mixtures thereof.

8. The process of claim 1 wherein the monomers, low molecular weight prepolymers, or low molecular weight polymerizable compounds comprise ethylene vinyl acetate.

9. The process of claim 1 wherein the composition comprises less than about 20% solvent.

10. The process of claim 1 wherein the composition comprises less than about 5% solvent.

11. The process of claim 1 wherein the microsheres have an expansion temperature, and wherein the temperature of the composition is at least 10 degrees F. below the expansion temperature of the microspheres.

12. A process for extruding a layer of a printing blanket comprising the steps of
providing a rubber composition,
maintaining the temperature of the rubber composition at a temperature where the rubber composition is extrudeable; and
extruding through a die a film adapted for use on a printing blanket, wherein the rubber composition contains less than about 40% solvent.

13. The process of claim 12 wherein the rubber composition contains less than about 20% solvent, and wherein the thickness of the film is between about 0.05 inches to about 0.20 inches, and wherein the printing blanket is a gapless and seamless cylindrical blanket.

14. The process of claim 12 wherein the rubber composition contains less than about 5% solvent.

15. The process of claim 12 wherein the rubber composition comprises microspheres, and wherein the extrusion temperature is between about 130° F. and about 250° F.

16. The process of claim 15 wherein the rubber composition comprises microspheres, and wherein the extrusion temperature is between about 150° F. and about 220° F.

17. The process of claim 12 wherein the film is in the form of a cylinder sized to fit at a layer of a printing blanket.

18. The process of claim 12 wherein the extrusion temperature is between about 130° F. to about 300° F.

19. The process of claim 12 wherein the extrusion temperature is between about 160° F. to about 250° F.

20. The process of claim 12 further comprising the step of affixing the extruded film to a printing blanket assembly.

21. The process of claim 20 wherein the film is a ribbon, and wherein the film is spiral wound around a printing blanket assembly.

22. The process of claim 20 wherein the extrudate is formed in a circular annulus die with the rubber composition being extruded over a held printing blanket assembly, wherein the outer edge of the die forms the outer diameter of the extruded composition and the inner edge is formed by a moving printing blanket which advances through the center of the die at a rate substantially equal to the rate of formation of the extrudate.

23. The printing blanket assembly of claim 12, wherein the printing blanket has an area adapted for printing, and wherein the printing area is devoid of threads winding around the printing area of the blanket.
